(19) United States
(12) Patent Application Publication
(10) Pub. No.: US 2013/0078547 A1
(43) Pub. Date: Mar. 28, 2013

(54) NANO-POROUS NANO-COMPOSITE, METHOD OF PREPARING THE SAME, AND SOLID OXIDE FUEL CELL INCLUDING THE NANO-POROUS NANO-COMPOSITE

(71) Applicant: Samsung Electronics Co., Ltd., Suwon-si (KR)

(72) Inventors: Hee-jung PARK, Suwon-si (KR); Sang-mock LEE, Yongin-si (KR); Chan KWAK, Yongin-si (KR)

(73) Assignee: SAMSUNG ELECTRONICS CO., LTD., Suwon-si (KR)

(21) Appl. No.: 13/680,021

(22) Filed: Nov. 17, 2012

Related U.S. Application Data
(62) Division of application No. 12/704,318, filed on Feb. 11, 2010.

(30) Foreign Application Priority Data
Feb. 11, 2009 (KR) 10-2009-0011214

(51) Int. Cl. B29B 9/12; H01M 8/12

(52) U.S. Cl. CPC B29B 9/12; H01M 8/12; B82Y 40/00
USPC 429/479; 264/12; 977/773; 977/948

(57) ABSTRACT

A nano-composite, including: a plurality of secondary particles, each secondary particle including a mixture of nano-size primary particles, wherein the mixture of nano-size primary particles includes particles including a nickel oxide or a copper oxide, and particles including zirconia doped with a trivalent metal element or ceria doped with a trivalent metal element, and wherein the nano-size primary particles define a plurality of nano-pores.

### CROSS-REFERENCE TO RELATED APPLICATIONS

This application is a divisional of U.S. application Ser. No. 12/704,318, filed on Feb. 11, 2010, which claims priority to Korean Patent Application No. 10-2009-0011214, filed on Feb. 11, 2009, and all the benefits accruing therefrom under 35 U.S.C. §119, the contents of which in their entirety are herein incorporated by reference.

### BACKGROUND

1. Field

One or more embodiments relate to a nano-porous nano-composite, a method of preparing the same and a solid oxide fuel cell (“SOFC”) including the nano-porous nano-composite.

2. Description of the Related Art

Recently, environmental and energy concerns related to the use and depletion of fossil fuels have drawn increased attention worldwide. To address these problems, great efforts have been devoted to research and commercialize solid oxide fuel cells (“SOFCs”), which convert chemical energy, generated from a reaction of hydrogen or a hydrocarbon and air, into electrical energy.

Most SOFC-related research institutes have recently conducted research into a composite of nickel oxide (NiO) and yttria-stabilized zirconia (“YSZ”).

A SOFC consists of a membrane-electrode assembly (“MEA”) including a solid electrolyte and electrodes. In particular, an anode of the SOFC, in which electrochemical reactions involving a fuel occur, is a core element that is desirably improved to facilitate the commercialization of SOFCs.

Electrochemical reactions in SOFCs involve a cathode reaction in which oxygen gas (O₂) supplied to the air electrode (cathode) changes into oxygen ions (O²⁻), and an anode reaction in which a fuel (H₂ or a hydrocarbon) supplied to the fuel electrode (anode) reacts with O²⁻, which migrates through an electrolyte. The cathode reaction and anode reaction are represented in Reaction Scheme 1 below:

Cathode: ½O₂+2e⁻→O²⁻

Anode: H₂+O²⁻→H₂O+2e⁻ Reaction Scheme 1

In an SOFC, the anode reaction is understood to occur at the triple phase boundary (“TPB”), i.e., at the interface between an electrical conductor (Ni), an ionic conductor (“YSZ”) and a gas phase (fuel), as shown in FIG. 1.

To improve SOFC performance, researchers have made efforts to increase the area of the TPB. In particular, with regard to a method of improving the durability of SOFCs, efforts have been made to lower the operating temperature thereof. However, this requires a reduction in polarization resistance, which can result from increasing the area of the TPB. Thus there remains a need for improved SOFC materials which can provide a TPB having an increased area.

### SUMMARY

One or more embodiments include a nano-composite having a nano-porous structure having an improved triple phase boundary (“TPB”) area and having a high degree of uniformity.

One or more embodiments include a method of preparing the nano-composite.

One or more embodiments include a solid oxide fuel cell (“SOFC”) including the nano-composite.

Additional aspects will be set forth in part in the description which follows and, in part, will be apparent from the description.

To achieve the above and/or other aspects, one or more embodiments include a nano-composite including a plurality of secondary particles, each secondary particle including a mixture of nano-size primary particles, wherein the mixture of nano-size primary particles includes particles including a nickel oxide or a copper oxide, and particles including zirconia doped with a trivalent metal element or ceria doped with a trivalent metal element, and wherein the nano-size primary particles define a plurality of nano-pores.

To achieve the above and/or other aspects, one or more embodiments include a method of preparing a nano-composite, the method includes: dissolving a nickel precursor or a copper precursor; a trivalent metal element precursor; and a zirconium precursor or a cerium precursor in a solvent to obtain a mixed solution; spraying the mixed solution using a spray; supplying the sprayed mixed solution along with a carrier gas into a furnace to form a sprayed product; and sintering the sprayed product.

To achieve the above and/or other aspects, one or more embodiments include a solid electrolyte fuel cell including: a fuel electrode layer; an air electrode layer; and an electrolyte membrane disposed between the fuel electrode layer and the air electrode layer, wherein the fuel electrode layer includes a nano-composite, the nano-composite including a plurality of secondary particles, each secondary particle including a mixture of nano-size primary particles, wherein the mixture of nano-size primary particles includes particles including a nickel oxide or a copper oxide, and particles including zirconia doped with a trivalent metal element or ceria doped with a trivalent metal element, and wherein the nano-size primary particles define a plurality of nano-pores.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of an exemplary embodiment of a triple phase boundary (“TPB”);

FIG. 2 is a graph of X-ray diffraction (“XRD”) patterns of the nano-composite powders prepared in Examples 1 through 4 illustrating intensity (arbitrary units) versus diffraction angle (degrees two-theta);

FIGS. 3A, 3B, 3C and 3D are scanning electron microscopic (“SEM”) images of the nano-composite powder prepared in Examples 1 through 4, respectively;

FIG. 4A shows ultra-high resolution (“UHR”)-SEM images of the nano-composite powder prepared in Example 1, and FIG. 4B shows an enlarged view of the indicated portion of FIG. 4A;

FIG. 5 shows a UHR-transmission electron microscopic (“TEM”) image and a result of energy dispersive X-ray spectroscopy (“EDS”) on portions of the nano-composite powder prepared in Example 1;

FIG. 6A shows UHR-SEM images of the nano-composite powder prepared in Example 2 and FIG. 6B shows an enlarged view of the indicated portion of FIG. 6A;

FIG. 7 shows a UHR-TEM image and a result of EDS on portions of the nano-composite powder prepared in Example 2;

FIG. 8A is a TEM image of the nano-composite YSZ-NiO powder prepared in Example 1, and FIGS. 8B and 8C show an enlarged views of a portion of FIG. 8A;

FIG. 8D is a TEM image of the nano-composite powder prepared in Example 2, and FIGS. 8E and 8F show an enlarged views of a portion of FIG. 8D;

FIG. 9 shows the results of EDS-mapping on a center portion of the nano-composite powder of Example 1; and

FIG. 10 is a graph of Brunauer-Emmett-Teller (“BET”) specific surface area (square meters per gram) with respect to pore size (nanometers, nm), as a result of a BET test on the nano-composite YSZ-NiO powder prepared in Examples 1 through 4.

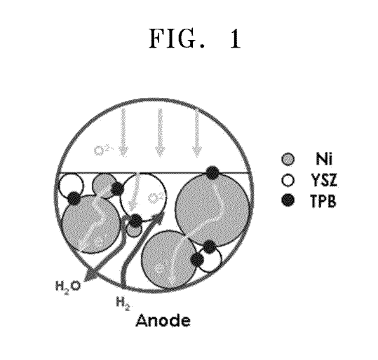

The patent or application file contains at least one drawing executed in color. Copies of this patent or patent application publication with color drawing(s) will be provided by the Office upon request and payment of the necessary fee.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs.

One or more embodiments include a nano-composite comprising a plurality of secondary particles, each secondary particle including nano-pores, the secondary particles comprising a mixture of nano-size primary particles, wherein the mixture of nano-size primary particles comprises particles comprising a nickel oxide or a copper oxide, and particles comprising zirconia doped with a trivalent metal element or ceria doped with a trivalent metal element. In an embodiment, the nano-size primary particles define a plurality of nano-pores. In an embodiment, the nano-composite has a nano-porous structure in which two kinds of nanoparticles are uniformly mixed and creases are formed in the surface of the nano-composite.

In the nano-composite, the nano-size primary particles, i.e., the particles comprising the nickel oxide or the copper oxide, and the particles comprising zirconia doped with a trivalent metal element or ceria doped with a trivalent metal element, do not substantially agglomerate, and thus are uniformly distributed. Due to the uniform distribution of the nano-size primary particles, the secondary particles, i.e., the nano-composite, may have a plurality of nano-pores, which are defined by the nano-size primary particles.

In addition, the nano-composite comprising the secondary particles, which may be formed by binding together the nano-size primary particles, may further have an irregular creased surface structure, which increases the surface area of the nano-composite.

As disclosed above, as the specific surface area of the nano-composite increases due to the nano-size particles and pores, the number of reaction sites is increased, thereby increasing the area of the triple phase boundary (“TPB”). In addition, the creased surface structure of the nano-composite may further increase the specific surface area of the nano-composite, thereby further increasing the area of the TPB.

The increase of the area of the TPB reduces polarization resistance, which enables a reduction in the operating temperature of a fuel cell. Thus, a SOFC including the nano-composite may have improved durability.

As used herein, the term “nano-scale” or “nano-size” refers to a size of about 1 nanometer (nm) to about 1,000 nm, unless specifically stated otherwise. In particular, when the term “nano-scale” or “nano-size” is used with respect to particles, it refers to particles having a very small particle size of about 1 nm to about 1,000 nm.

As used herein, the term “particle size” refers to the average largest dimension of the particles. Alternatively “particle size” refers to the average diameter of an equivalent spherical volume of the particles, or refers to the average particle size as determined using Scherrer analysis of X-ray powder diffraction data, the Brunauer-Emmett-Teller (‘BET”) method or SEM image analysis. Further as used herein, “pore size” refers to the pore size as determined using the Brunauer-Emmett-Teller (‘BET”) method or the Barrett-Joyner-Halenda (“BJH”) method for finding specific surface area as described herein.

The particles comprising nickel oxide or copper oxide and the particles comprising zirconia doped with a trivalent metal element or ceria doped with a trivalent metal element, which together constitute the primary particles of the nano-composite, may have a nano-scale size, for example, an average largest diameter of about 0.1 to about 100 nm, specifically about 1 to about 30 nm, more specifically about 2 to about 20 nm. In an embodiment, the primary particles may have a particle size of about 1 nm to about 30 nm. The primary particles may also have a particle size of about 1 nm to about 20 nm.

Examples of the trivalent metal element doped in the zirconia or the ceria include yttrium (Y), scandium (Sc), samarium (Sm), gadolinium (Gd) or a combination comprising at least one of the foregoing. In addition, examples of the zirconia doped with a trivalent metal element or ceria doped with a trivalent metal element include yttrium-stabilized zirconia (“YSZ”), scandium-stabilized zirconia (“ScSZ”), samarium-doped ceria (“SDC”), gadolinium-doped ceria (“GDC”), or the like or a combination comprising at least one of the foregoing.

As the primary particles are uniformly distributed in the secondary particles, i.e., the nano-composite, a plurality of pores may be formed between (e.g., defined by) the primary particles. In particular, because the primary particles do not agglomerate and have a nano-scale size, the pores defined by the primary particles may have a nano-scale size. For example, the nano-scaled pore size may be about 0.1 to about 100 nm, specifically about 1 nm to about 30 nm, more specifically about 1 nm to about 20 nm, on average. Herein, uniform distribution of the primary particles may imply that a mole ratio between the nickel oxide or copper oxide and zirconia doped with a trivalent metal element or ceria doped with a trivalent metal element are similar within a radius of the nano-composite particle.

As the primary particles have a nano-scale size and the pores between (e.g., defined by) the primary particles have a nano-scale size, and the nano-composite including the primary particles and the nano-pores may have a nano-scale particle size. For example, the nano-composite may have a particle size of about 10 nm to about 1000 nm, specifically about 20 nm to about 900 nm, more specifically about 30 nm to about 800 nm.

The nano-composite may have an increased specific surface area, for example, a specific surface area of about 1 to about 10 square meters per gram (m²/g), specifically about 2 to about 9 m²/g, more specifically about 5 m²/g. The specific surface area may be measured using the Barrett-Joyner-Halenda (“BJH”) method. In addition, due to the nano-scale particle size, the nano-composite may have a higher degree of porosity, for example, a porosity of about 5 to about 30 percent (%), specifically about 10 to about 25 percent, more specifically about 15 to about 20 percent.

In addition, the nano-composite may have an irregular, creased surface structure, which further increases the specific surface area and the porosity of the nano-composite.

Due to the creased surface structure of the nano composite, the specific surface area of the nano composite may be about 1 to about 100 m²/g, specifically about 2 to about 90 m²/g, more specifically about 4 m²/g to about 70 m²/g, and the porosity may be about 15 to about 50%, specifically about 20 to about 45%, more specifically about 25 to about 40%. Specific surface area can be measured using the Barrett-Joyner-Halenda (“BJH”) method. Porosity can be measured using the BET method.

The nano-composite may be prepared according to the following method.

Initially, a nickel precursor or a copper precursor, a trivalent metal element precursor and a zirconium precursor or a cerium precursor are dissolved and mixed in a solvent to obtain a mixed solution. The mixed solution is sprayed through a nozzle using a sprayer and supplied into a furnace along with a carrier gas, and then sintered to obtain the nano-composite.

The sprayer may be an ultrasonic sprayer, a spray gun, an air sprayer, an air response sprayer, an electrostatic sprayer or a rotating fog sprayer.

The solvent may be, but is not limited to, any solvent that can dissolve the precursor. Exemplary solvents include lower alcohols having five or fewer carbon atoms, such as methanol, ethanol, 1-propanol, 2-propanol, butanol or a combination comprising at least one of the foregoing alcohols; water; toluene; or a combination comprising at least one of the foregoing solvents.

Examples of the nickel precursor include nickel chloride, nickel nitrate, nickel acetylacetonate hydrate, nickel acetate, nickel sulfide, or the like or a combination comprising at least one of the foregoing. Examples of the copper precursor include copper chloride, copper nitrate, copper acetylacetonate hydrate, copper acetate, copper sulfide, or the like or a combination comprising at least one of the foregoing.

Examples of the zirconium precursor include zirconium chloride, zirconium nitrate, zirconium acetylacetonate hydrate, zirconium acetate, zirconium sulfide, zirconium ethoxide, zirconium acetate, zirconium monostearate, or the like or a combination comprising at least one of the foregoing. Examples of the cerium precursor include cerium chloride, cerium nitrate, cerium acetylacetonate hydrate, cerium sulfide, cerium ethoxide, cerium acetate, cerium monostearate, or the like or a combination comprising at least one of the foregoing.

Examples of the trivalent metal element precursor include an yttrium (Y) precursor, a scandium (Sc) precursor, a samarium (Sm) precursor, a gadolinium (Gd) precursor, or the like or a combination comprising at least one of the foregoing. Examples of the yttrium precursor include yttrium chloride, yttrium nitrate, yttrium acetylacetonate hydrate, yttrium fluoride, yttrium acetate, yttrium sulfate, or the like or a combination comprising at least one of the foregoing. Examples of the scandium precursor include scandium chloride, scandium nitrate, scandium acetylacetonate hydrate, scandium fluoride, scandium acetate, scandium sulfate, or the like or a combination comprising at least one of the foregoing. Examples of the samarium precursor include samarium chloride, samarium nitrate, samarium acetylacetonate hydrate, samarium acetylacetonate hydrate, samarium fluoride, samarium acetate, samarium sulfate, or the like or a combination comprising at least one of the foregoing. Examples of the gadolinium precursor include gadolinium chloride, gadolinium nitrate, gadolinium acetylacetonate hydrate, gadolinium fluoride, gadolinium acetate, gadolinium sulfate, or the like or a combination comprising at least one of the foregoing.

The above-listed precursors may be used in a selected concentration. The concentration of each of the foregoing precursors may be individually selected to be about 0.01 to about 1 mole per liter (mol/liter), specifically about 0.05 to about 0.5 mol/liter, more specifically about 0.1 to about 0.1 mol/liter. Alternatively, the concentration of each of the precursors may individually selected to be about 0.1 to 0.5 mol/liter. When the concentration of each of the precursors is within the above range, complex formation reactions may smoothly occur, and agglomeration of particles may be substantially reduced or effectively prevented. The concentration of each of the precursors may be appropriately varied according to the composition of the nano-composite to be prepared.

After the nickel precursor or copper precursor, the trivalent metal element precursor, and the zirconium precursor or cerium precursor have been dissolved in the solvent to obtain the mixed solution, the nano-composite is formed from the mixed solution by pyrolysis, for example, by ultrasonic spray pyrolysis (“USP”).

USP refers to a method of forming a composite by ultrasonically spraying a source material and supplying the source material along with a carrier gas into a furnace, and then sintering and trapping the resulting product.

Ultrasonic waves applied in the USP may have a frequency range of about 0.1 to about 10 megahertz (MHz), specifically, about 0.5 to about 8 MHz, more specifically about 1 to about 6 MHz.

The carrier gas used in the USP may be, but is not limited to, a gas that does not impede the formation of the nano-composite, for example, air, nitrogen, argon, helium, oxygen or a combination comprising at least one of the foregoing.

The mixed solution for forming the nano-composite may be sprayed, for example, at a rate of about 0.001 to about 10 liters per minute (liters/min), specifically about 0.01 to about 5 liters/min, more specifically about 0.1 to about 1 liters/min.

The mixed solution along with the carrier gas may be supplied to the furnace for several seconds to several minutes, specifically a time of about 1 second to about 60 minutes, more specifically about 10 seconds to about 30 minutes. The furnace may include a low-temperature portion having a temperature of about 100 to about 400° C., specifically about 150 to about 350° C., more specifically 200 to about 300° C., and a high temperature portion having a temperature of about 600 to about 1200° C., specifically about 700 to about 1100° C., more specifically about 800 to about 1000° C.

The mixed solution sprayed to form the nano-composite is subjected to processes which may include decomposition, evaporation or oxidation processes, resulting in primary particles. The primary particles formed initially form secondary particles through sintering.

After the sintering process is completed, the resulting powder is trapped outside the furnace to yield the nano-composite.

In the processes of preparing the nano-composite, the mixed solution may further include a water-soluble polymer. The water-soluble polymer may decompose and evaporate in the sintering process, thereby forming additional pores in the nano-composite. The water-soluble polymer may result in an irregular, creased structure on the surface of the nano-composite.

The water-soluble polymer may be, but is not limited to, any water soluble polymer, for example, polyvinylpyrolidone, polyvinyl alcohol, polyacrylic acid or a combination comprising at least one of the foregoing. The water-soluble polymer may have, but is not limited to, a number average molecular weight or a weight average molecular weight of about 1,000 to about 1,000,000 daltons, specifically about 10,000 to about 100,000 daltons, more specifically about 50,000 daltons.

The water-soluble polymer may be added in an amount of about 0.1 to about 10 parts by weight, specifically about 0.5 to about 8 parts by weight, more specifically about 1 to about 6 parts by weight, based on 100 parts by weight of the solvent. Alternatively, the amount of the water-soluble polymer may be contained in an amount of about 0.1 to about 5 parts by weight, based on 100 parts by weight of the solvent. When the amount of the water-soluble polymer is within the above ranges, the above-described effect of adding the water-soluble polymer is attainable, and the water-soluble polymer does not precipitate or increase the viscosity of the mixed solution, either of which may obstruct spraying of the mixed solution.

The nano-composite prepared as described above may be used in various industrial fields, for example, in solid oxide fuel cells (“SOFCs”).

One or more embodiments include a SOFC including a fuel electrode layer, an air electrode layer, and an electrolyte membrane disposed between the fuel electrode layer and the air electrode layer, wherein the fuel electrode layer includes the nano-composite prepared according to the method disclosed above.

The electrolyte membrane may comprise at least one composite metal oxide in particle form selected from the group consisting of zirconium oxide, cerium oxide and lanthanum oxide, which are known as electrolyte materials for SOFCs. Examples of the electrolyte membrane material in particle form include yttrium-stabilized zirconia (“YSZ”), scandium-stabilized zirconia (“SSZ”), samarium-doped ceria (“SDC”), gadolinium-doped ceria (“GDC”), and the like or a combination comprising at least one of the foregoing. The electrolyte membrane may have a thickness of about 10 nanometers (nm) to about 100 micrometers (μm), specifically about 50 nm to about 50 μm, more specifically about 100 nm to about 1 μm. Alternatively, the electrolyte membrane may have a thickness of about 100 nm to 50 μm.

The air electrode layer may comprise a metal oxide in particle form having a perovskite crystal structure. The air electrode layer may include, for example, (Sm,Sr)CoO₃, (La,Sr)MnO₃, (La,Sr)CoO₃, (La,Sr)(Fe,Co)O₃, (La,Sr)(Fe,Co,Ni)O₃, a combination comprising at least one of the foregoing or a combination of at least two thereof. In an embodiment, these metal oxides in particle form may be used alone or in combination with at least two thereof. In addition, the air electrode layer may comprise a precious metal, such as platinum (Pt), ruthenium (Ru), palladium (Pd) or a combination comprising at least one of the foregoing.

The nano-composite prepared using the method disclosed above may be used as a material for the fuel electrode layer. Alternatively, the metal oxide in particle form constituting the electrolyte membrane may be further added to the material for the fuel electrode layer.

The disclosed embodiments will now be described in further detail with reference to the following examples. These examples are for illustrative purposes only and are not intended to limit the scope of this disclosure.

### EXAMPLE 1

To prepare a nano-composite of nickel oxide (NiO) and yttrium-stabilized zirconia (YSZ) in a ratio of 6:4, nickel nitrate, zirconium nitrate and yttrium nitrate were dissolved in 100 milliliters (ml) of purified water to provide a 0.2 molar (M) mixed solution.

The mixed solution was sprayed through inlet nozzles of a furnace using an ultrasonic sprayer (SUH-800SUS, frequency: 1.7 MHz, SHINIL INDUSTRIAL CO., LTD) and supplied into the furnace along with a carrier oxygen gas at a rate of 1.5 liters per minute (liters/min). The furnace included two portions, one portion set to 400° C. and the other portion set to 900° C. The mixed gas was passed through the furnace for several seconds. After the sintering process was completed, the resulting powder was trapped outside the furnace to yield the nano-composite YSZ-NiO in powder form.

### EXAMPLE 2

A nano-composite YSZ-NiO powder was obtained using the same process as in Example 1, except that 0.1 gram (g) of polyvinylpyrolidone was further dissolved along with the nickel nitrate, zirconium nitrate and yttrium nitrate to obtain the mixed solution.

### EXAMPLE 3

A nano-composite YSZ-NiO powder was obtained using the same process as in Example 1, except that 0.3 g of polyvinylpyrolidone was further dissolved along with the nickel nitrate, zirconium nitrate and yttrium nitrate to obtain the mixed solution.

### EXAMPLE 4

A nano-composite YSZ-NiO powder was obtained using the same process as in Example 1, except that 1.0 g of polyvinylpyrolidone was further dissolved along with the nickel nitrate, zirconium nitrate and yttrium nitrate to obtain the mixed solution.

### EXPERIMENTAL EXAMPLE

An X-ray diffraction (“XRD”) analysis, a scanning electron microscopic (“SEM”) analysis, a transmission electron microscopic (“TEM”) analysis and a Brunauer-Emmett-Teller (“BET”) test were performed on the nano-composite YSZ-NiO powder prepared in Examples 1 through 4.

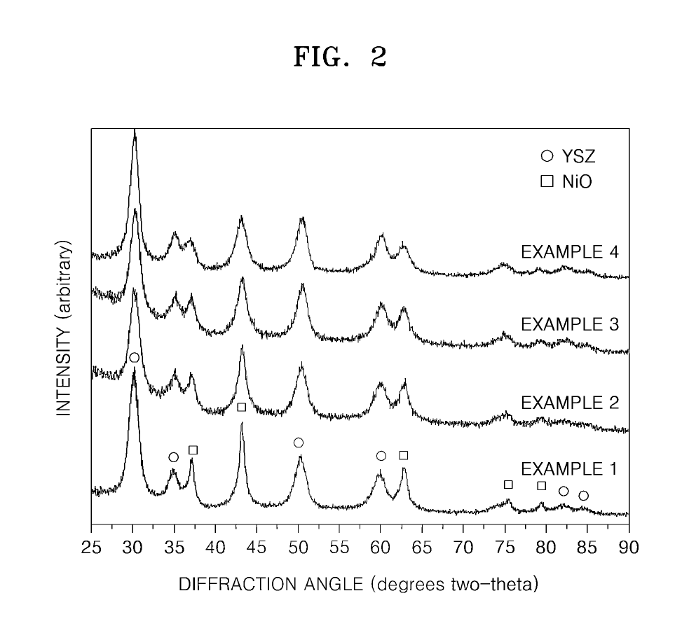

FIG. 2 is a graph of XRD patterns of the nano-composite YSZ-NiO powder prepared in Examples 1 through 4. It can be seen in FIG. 2 that peaks of YSZ and NiO are detected. This implies that YSZ and NiO individually form single phases. The average particle sizes of YSZ and NiO powder were measured based on the widths of the peaks according to the Scherrer equation. The results are shown in Table 1. The peak having the largest intensity of each of the samples was used for calculating the average particle sizes of YSZ and NiO. As can be seen from the results in Table 1, the average particle sizes of YSZ and NiO are around 10 nm. In addition, the average particle sizes of YSZ and NiO powder prepared in Example 1 are smaller than the average particle sizes of YSZ and NiO powder of Examples 2 through 3 to which polyvinylpyrolidone was added.

TABLE 1

| Item | Example 1 | Example 2 | Example 3 | Example 4 |
|---|---|---|---|---|
| YSZ particle size (nm) | 6 | 4 | 4 | 6 |
| NiO particle size (nm) | 11 | 7 | 8 | 6 |

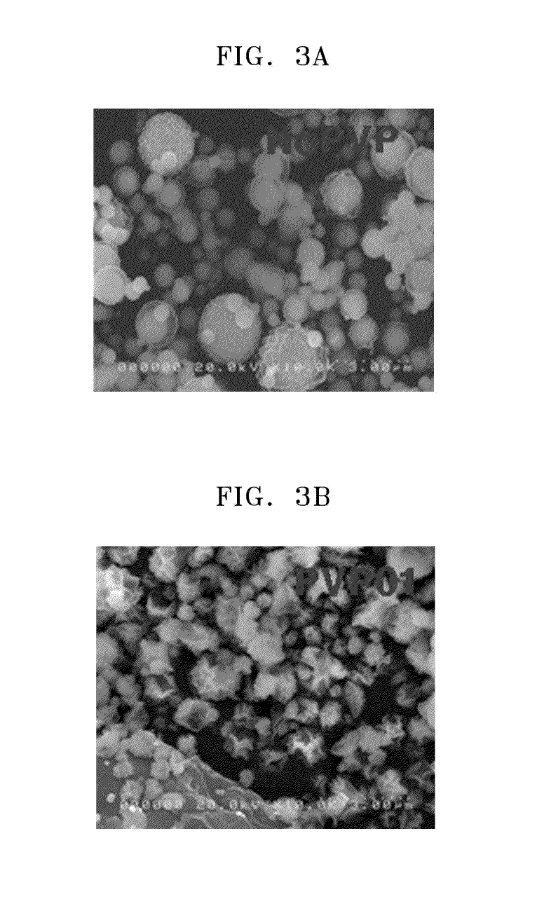

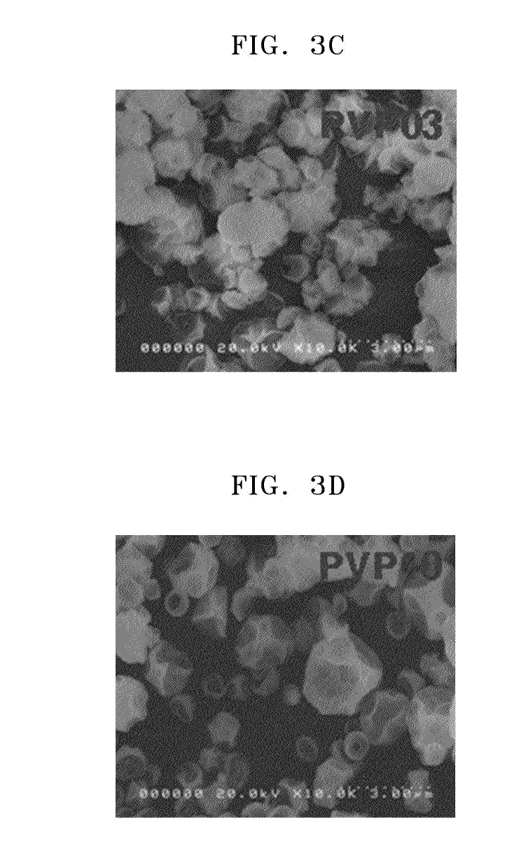

FIGS. 3A, 3B, 3C and 3D are SEM images of the nano-composite YSZ-NiO powders prepared in Examples 1 through 4, respectively. As can be seen in FIG. 3A, the nano-composite YSZ-NiO powder of Example 1 has a spherical shape. As shown in FIGS. 3B, 3C and 3D, the nano-composite YSZ-NiO powder of Examples 2 through 4 are similar in size to the nano-composite YSZ-NiO powder of Example 1, and have a very irregular creased surface structure.

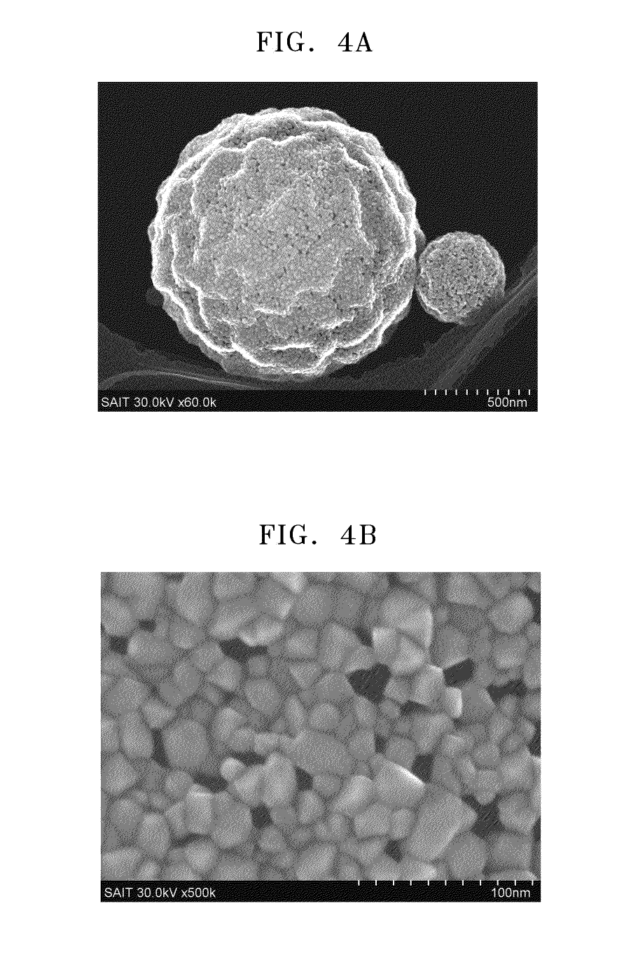

FIGS. 4A and 4B show ultra-high resolution (“UHR”)-SEM images of the nano-composite YSZ-NiO powder prepared in Example 1, in which FIG. 4B is an enlarged view of the indicated portion of FIG. 4A. As can be seen from FIGS. 4A and 4B, secondary particles of the nano-composite YSZ-NiO powder having a submicrometer or micrometer diameter consist of nano-size primary particles and nano-pores. The primacy particles of the nano-composite YSZ-NiO powder of Example 1 have an average largest diameter of about 16 nm, and the nano-composite YSZ-NiO powder of Example 1 has an average largest pore diameter of about several to about tens of nanometers.

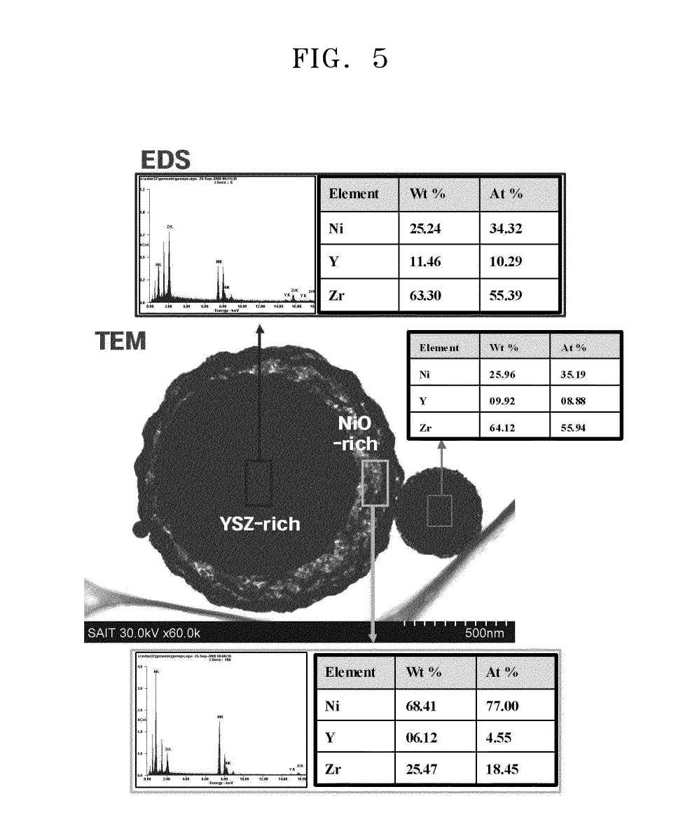

FIG. 5 shows a UHR-TEM image and a result of energy dispersive X-ray spectroscopy (“EDS”) on portions of the nano-composite YSZ-NiO powder prepared in Example 1. As can be seen from the results of the EDS analysis shown in FIG. 5, YSZ and NiO are both present in the nanocomposite, and two the phases are mixed. Thus, for the nano-composite YSZ-NiO powder of Example 1, the area of triple phase boundaries is markedly increased compared to a common, simple mixture of NiO powder and YSZ powder.

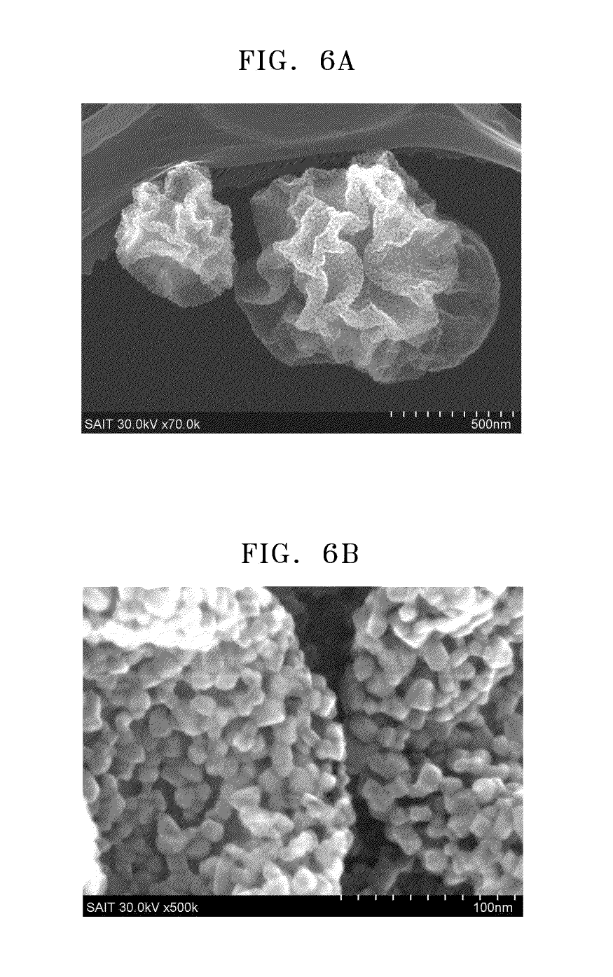

FIGS. 6A and 6B show UHR-SEM images of the nano-composite YSZ-NiO powder prepared in Example 2, in which FIG. 6B is an enlarged view of the indicated portion of FIG. 6A. As can be seen in FIGS. 6A and 6B, similar to the nano-composite YSZ-NiO powder of Example 1, secondary particles of the nano-composite YSZ-NiO powder of Example 2 consist of nano-size primary particles and nano-size pores.

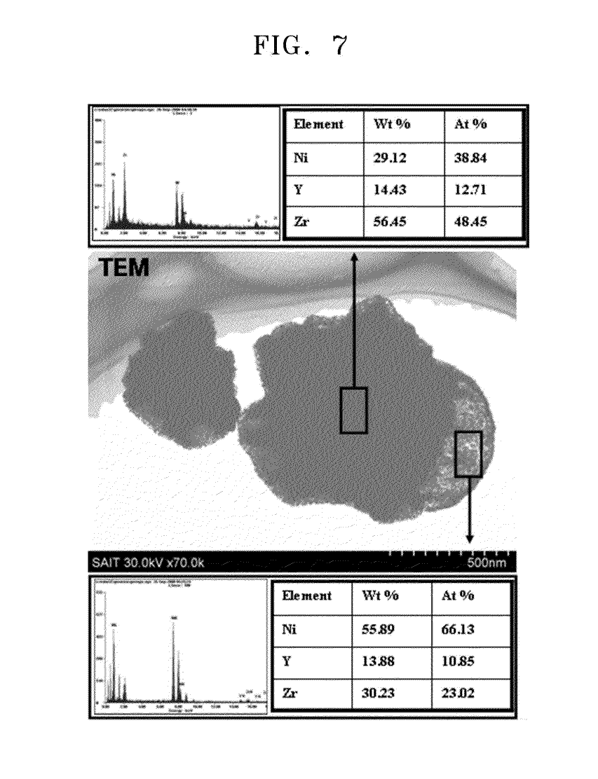

FIG. 7 shows a UHR-TEM image and a result of EDS analysis on portions of the nano-composite YSZ-NiO powder prepared in Example 2. Referring to FIG. 7, similar to the nano-composite YSZ-NiO powder of Example 1, YSZ and NiO are both present and are apart from each other in the particle; however, a compositional difference between the inner and outer portions of the nano-composite YSZ-NiO powder is decreased compared to the nano-composite YSZ-NiO powder of Example 1. In addition, the shape of the nano-composite YSZ-NiO powder of Example 2 is highly deformed, and thus the nano-composite YSZ-NiO powder of Example 2 has an irregular, creased structure.

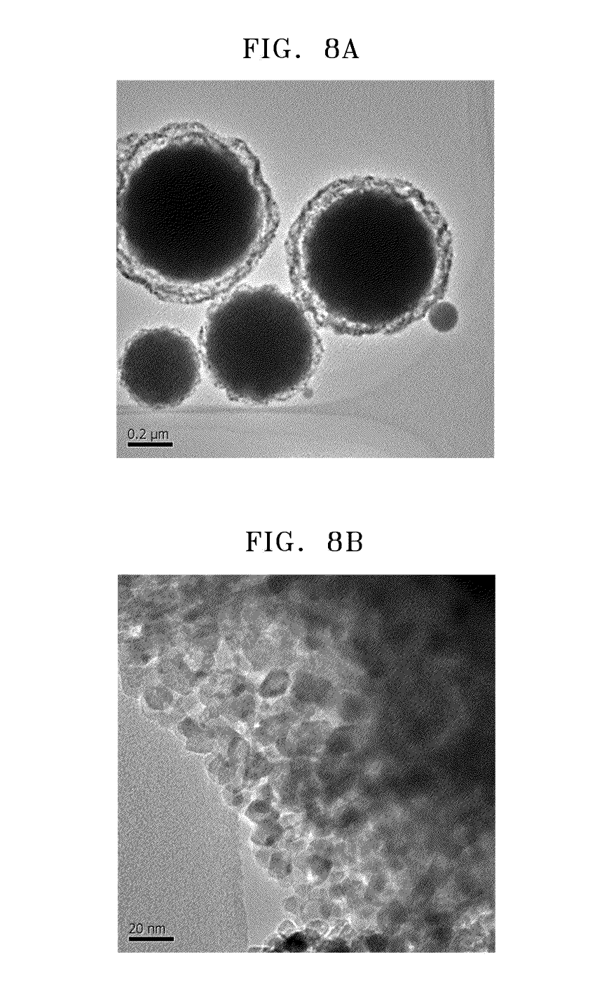

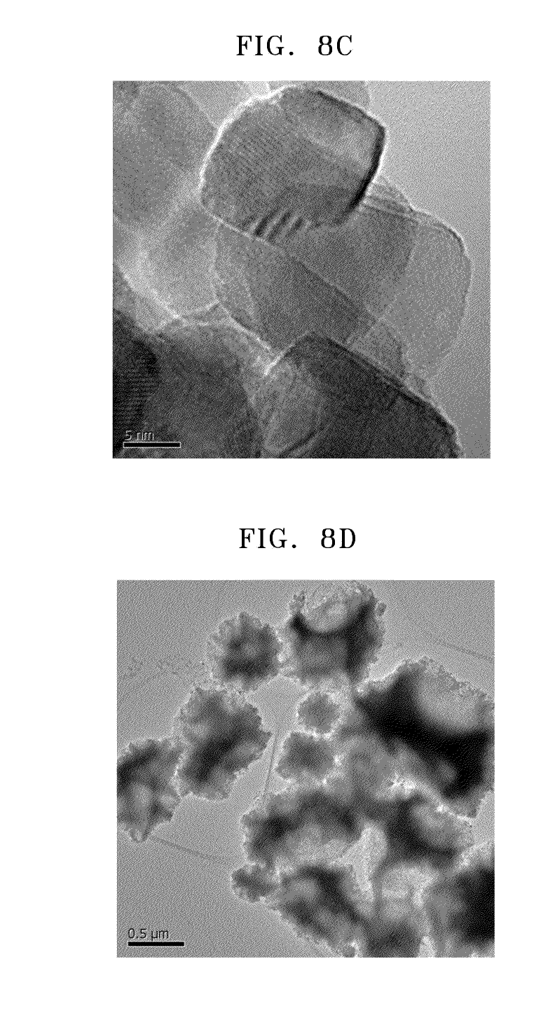

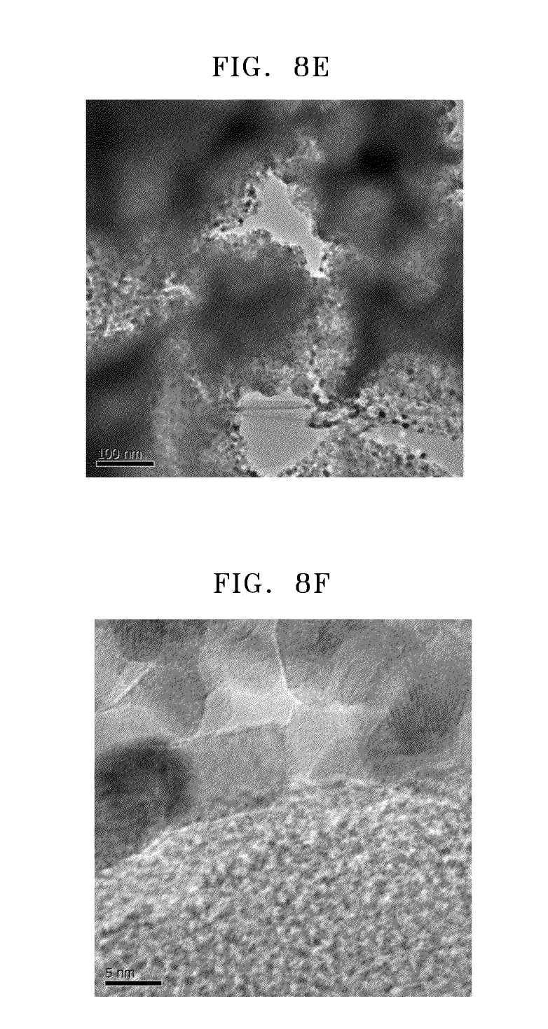

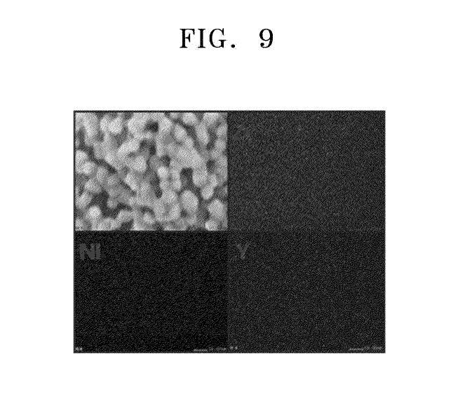

FIGS. 8A to 8C are TEM images of the nano-composite YSZ-NiO powder prepared in Example 1, and FIGS. 8D to 8F are TEM images of the nano-composite YSZ-NiO powder prepared in Example 2. It can be seen from FIGS. 8A to 8F that the nano-composite YSZ-NiO powder of Example 2 has considerably more nano-pores than the nano-composite YSZ-NiO powder of Example 1.

FIGS. 6, 7 and 8A to 8F show that the nano-composite YSZ-NiO powder of Example 2 has an average particle diameter that is 9 nm smaller than the nano-composite YSZ-NiO powder of Example 1 and includes much more nano-pores, and the phase separation between NiO and YSZ of the nano-composite YSZ-NiO powder of Example 2 is reduced, thus resulting in a higher degree of uniformity. The increased content of nano-pores increases the area of triple phase boundaries (“TPBs”).

FIG. 9 shows the results of EDS-mapping on a center portion of the nano-composite YSZ-NiO powder of Example 1. Referring to FIG. 9, the nano-composite YSZ-NiO powder of Example 1 is uniform.

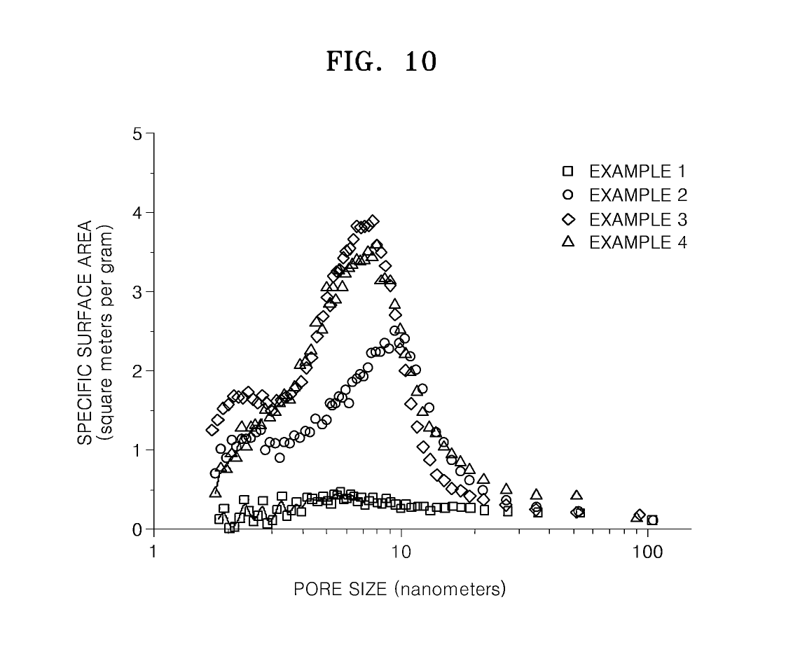

FIG. 10 is a graph of Brunauer-Emmett-Teller (BET″) specific surface area with respect to pore size, as a result of the BET test on the nano-composite YSZ-NiO powder prepared in Examples 1 through 4. FIG. 10 shows the distribution of nano-size pores in the nano-composite YSZ-NiO powder of Examples 1 through 4. As can be seen from FIG. 10, the sizes of the nano-pores are mostly smaller than 20 nm, and the number of nano-pores is markedly increased in the nano-composite YSZ-NiO powder of Examples 2 through 4 to which polyvinylpyrolidone was added.

The results of the BET test, i.e., the specific surface area and the average size and volume of nano-pores of the nano-composite YSZ-NiO powder prepared in Examples 1 through 4, are shown in Table 2 below. For a Comparative Example, gadolinium-doped (10% Gd) ceria nano-powder, which is used as a material for commercially available fuel cells, was used. As shown in Table 2, the nano-composite YSZ-NiO powder of Example 4 has the largest BET specific surface area.

TABLE 2

| | BET specific surface area | Average pore size | Pore volume |
|---|---|---|---|
| Items | (m²/g) | (nm) | (m³/g) |
| Comparative | 1 | — | — |
| Example | | | |
| Example 1 | 5.60 | 21 | 0.02 |
| Example 2 | 14.87 | 15 | 0.06 |
| Example 3 | 19.66 | 11 | 0.06 |
| Example 4 | 20.22 | 14 | 0.08 |

As described above, a nano-composite that includes nano-pores is provided through a simple process. The area of triple phase boundaries where ionic conductors, electron conductors and pores coexist is increased in the nano-composite. Thus, the nano-composite may be applicable in various industrial fields, for example, in SOFCs.

It should be understood that the exemplary embodiments described therein should be considered in a descriptive sense only and not for purposes of limitation. Descriptions of features or aspects within each embodiment should be considered as available for other similar features or aspects in other embodiments.

What is claimed is:

1. A method of preparing a nano-composite, the method comprising:
dissolving a nickel precursor or a copper precursor; a trivalent metal element precursor; and a zirconium precursor or a cerium precursor in a solvent to obtain a mixed solution;
spraying the mixed solution using a spray;
supplying the sprayed mixed solution along with a carrier gas into a furnace to form a sprayed product; and
sintering the sprayed product.

2. The method of claim 1, wherein the copper precursor comprises at least one selected from the group consisting of copper chloride, copper nitrate, copper acetylacetonate hydrate, copper acetate, copper sulfide and a mixture comprising at least one of the foregoing,
the nickel precursor comprises at least one selected from the group consisting of nickel chloride, nickel nitrate, nickel acetylacetonate hydrate, nickel acetate, nickel sulfide and a mixture comprising at least one of the foregoing,
the copper precursor comprises at least one selected from the group consisting of zirconium chloride, zirconium nitrate, zirconium acetylacetonate hydrate, zirconium acetate, zirconium sulfide, zirconium ethoxide, zirconium acetate, zirconium monostearate and a mixture comprising at least one of the foregoing,
the cerium precursor comprises at least one selected from the group consisting of cerium chloride, cerium nitrate, cerium acetylacetonate hydrate, cerium sulfide, cerium ethoxide, cerium acetate, cerium monostearate and a mixture comprising at least one of the foregoing, and
the trivalent metal element precursor comprises at least one selected from the group consisting of a yttrium precursor, a scandium precursor, a samarium precursor, a gadolinium precursor and a mixture comprising at least one of the foregoing.

3. The method of claim 1, wherein a concentration of each of the nickel precursor or the copper precursor, the trivalent metal element precursor, and the cerium precursor or the zirconium precursor is about 0.01 to about 1 mole per liter.

4. The method of claim 1, wherein the mixed solution further comprises a water-soluble polymer in an amount of about 0.1 to about 10 parts by weight, based on 100 parts by weight of the solvent.

5. The method of claim 4, wherein the water-soluble polymer comprises at least one selected from the group consisting of polyvinylpyrolidone, polyvinylalcohol, polyacrylic acid and a mixture comprising at least one of the foregoing.

6. A solid electrolyte fuel cell, comprising:
a fuel electrode layer;
an air electrode layer; and
an electrolyte membrane disposed between the fuel electrode layer and the air electrode layer, wherein the fuel electrode layer comprises a nano-composite, the nano-composite comprising
a plurality of secondary particles, each secondary particle comprising a mixture of nano-size primary particles, wherein the mixture of nano-size primary particles comprises
particles comprising a nickel oxide or a copper oxide, and
particles comprising zirconia doped with a trivalent metal element or ceria doped with a trivalent metal element, and
wherein the nano-size primary particles define a plurality of nano-pores.
